(19) United States
(12) Patent Application Publication
(10) Pub. No.: US 2020/0015507 A1
(43) Pub. Date: Jan. 16, 2020

(54) METHOD AND DEVICE FOR CORING A LETTUCE HEAD AND INSTALLATION FOR INDUSTRIAL PEELING OF A LETTUCE HEAD

(71) Applicant: FLORETTE HOLDING, Lessay (FR)

(72) Inventor: Laurent SAVARY, Lessay (FR)

(21) Appl. No.: 16/504,711

(22) Filed: Jul. 8, 2019

(30) Foreign Application Priority Data
Jul. 11, 2018 (FR) 1856363

(51) Int. Cl. A23N 7/00; A23N 15/00; B26F 3/00

(52) U.S. Cl. CPC A23N 7/00; B26F 3/004; A23N 15/00

(57) ABSTRACT

A method of coring a lettuce head, consisting in cutting the lettuce head (TS) transversely with respect to its axis (RR), above the core (TR), leaving a residue (E4) formed by the core and the remains of the leaves, while the residue (E4) is rotated about its axis while a jet of cutting water forming a cutting line (AA) is directed toward the base of the rotating residue (RR) to separate the leaf remains from the core (TR).

### FIELD OF THE INVENTION

This invention relates to a method for coring a lettuce head after stripping the outer leaves and partial cutting into leaf pieces, as well as a coring device for implementing the method and an industrial setup for peeling lettuce heads applying the method and/or the coring device. More generally, the invention applies to the coring of all types of vegetables requiring such an operation.

### STATE OF THE TECHNIQUE

It is known that lettuce heads can be peeled industrially by cutting them gradually after first cutting off the edges of leaves that are inedible then successively cutting the leaves depending on their quality or their taste or food interest.

The final step is to detach the bases from the leaf pieces held by the core. To do this, the residue from the lettuce head, the core of which is carried by a rotating support, is run through a core cutting station. The station has a knife comprising a blade mounted on an actuator to be inserted at an angle in the core while the core is being rotated by the rotating holder. This operation removes the pieces from the core. Then the core is taken off and the holder is put back into circulation to be fitted with a new head of lettuce to peel.

This is an interesting solution for coring, but the blade used for the operation is exposed to the variable characteristics of the cores or lettuce head base which may still contain grains of soil or other relatively hard elements that quickly blunt the blade. In such cases, the operation of the installation has to be stopped to change the blade that will be sharpened.

There are also lettuces such as iceberg or Radicchio whose cores are almost impossible to cut with a knife as described above.

Because of very variable resistance encountered by the blade in the different cores, it does not blunt regularly in the course of time, making it relatively difficult to predict when to change the blade.

Thus, the drawback of this operation is that is requires the installation to be shut down for blade replacement at relatively random intervals, to the detriment of the proper operation and efficiency of the installation. It is also difficult to position the blade accurately in the core due to the flexibility of the blade and the difficulties it faces in penetrating the core.

Under these conditions, a relatively large safety distance must be provided between the devices attaching the to the rotating support and the line of action of the blade cutting the core. It generates substantial product losses.

### SCOPE OF THE INVENTION

The purpose of this invention is to develop means of precisely coring a lettuce head, even with a hard core, without interrupting the operation of the installation to replace the cutting device and to reduce losses by more precisely positioning the core cutting point at the base of the leaves.

### BRIEF AND ADVANTAGES OF THE INVENTION

Accordingly, the purpose of the present invention is a method of coring a lettuce head, characterized in that the lettuce head is cut transversely with respect to its axis, above the core, leaving a residue formed by the core and the remains of the leaves, while the residue is rotated about its axis as a jet of cutting water forming a cutting line is directed toward the base of the rotating residue to separate the leaf remains from the core.

This process has the advantage of cutting the core efficiently at the base of the lettuce head as closely as possible, since the head has already been partially cut to separate certain parts of the leaves, generally put into different quality categories.

This method no longer requires the replacement of the cutting blade to trim the core, allowing faster and more efficient coring with a higher efficiency than the known coring process.

Most advantageously, the strength of the cutting jet is set according to the different hardnesses of the core and leaf ribs so that the cutting axis shaves the surface of the core and cuts the base of the main rib of the lettuce leaves without cutting the core.

With the strength of the cutting jet thus adjusted and with a cutting axis is steeply inclined with respect to the core axis, it makes it possible to “follow” the surface of the core to cut the leaf rib bases without affecting or cutting the core. This produces very precise, efficient coring, not hindered by inaccuracies in the inclination of the cutting axis that would be caused by the natural shapes of the lettuce head cores not being strictly identical.

According to another characteristic, the axis of the cutting jet is oriented so that it is substantially tangent to a middle point with respect to the surface of the core TR.

Thus, the power adjustment as developed above, allows the cutting axis to follow the curved shape of the core surface and ensure effective coring even in the case of lettuces with particularly hard cores since the cutting axis does not have to cut the core.

The invention also refers to an industrial process for peeling the heads of lettuces using this coring process. This industrial peeling process is characterized in that each lettuce head is fixed to a rotating axis support, different leaf parts of the lettuce head are successively cut by rotating the head with the rotating support about its axis in front of knives to cut successive pieces of leaves, the lettuce head being finally cut transversely to its axis just above the end of the core leaving a residue of leaves, the residue is rotated and the jet of cutting water (cutting axis) is directed at the base of the core to the beginning of the leaves to separate the leaf pieces and the core.

The invention also concerns a device for coring lettuce heads for a peeling installation comprising: a rotating support for receiving the lettuce head attached to the support by its core, oriented per the axis of rotation of the support, a transverse cutting device for cutting the lettuce head transversely to its axis just above the core and forming a residue comprising the core and the base of the leaves from the core, a cutting water jet lance, mounted adjustably so that its cutting axis intercepts the volume of residue at the base of the leaves, an over-pressured water supply to the monitor and a control unit managing the operation of the transverse cutting element, of the rotating support and of the cutting water jet monitor.

This coring device is particularly compatible with an industrial lettuce head peeling installation comprising a set of rotating supports for transferring lettuce heads between the input of the installation and the evacuation of the stripped core of the lettuce leaves, a feeding station for loading the lettuce heads on the rotating supports, a succession of cutting stations to successively cut pieces of leaves depending to the products to be obtained, a coring device as specified above, downstream of the cutting stations to trim the core of the residue, collect the rest of the leaves and evacuate the stripped core and an installation management unit handling the synchronized operation of the coring device and the other components of the installation.

Another advantageous feature of the industrial peeling plant is that the set of rotating supports for transferring lettuce heads comprises a carousel around which the various cutting stations and the coring device are arranged.

### ILLUSTRATIONS

This invention will be described below in greater detail by means of a method for coring a lettuce head and a coring device and an industrial peeling installation for a lettuce head using the method and/or device(s) illustrated in the attached drawings in which:

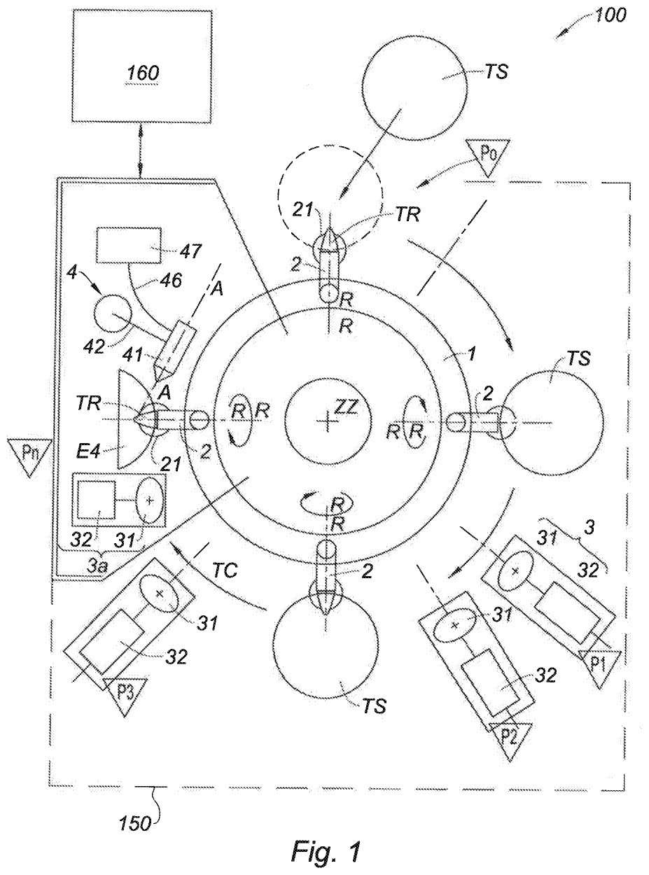

FIG. 1 is a schematic plan view of an industrial lettuce head peeling device according to the invention;

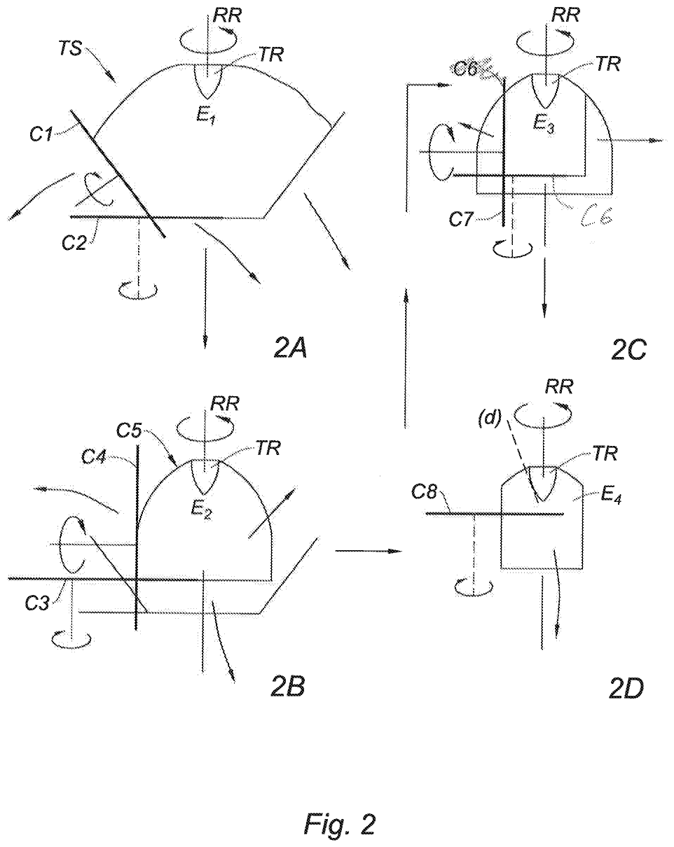

FIG. 2 is an explanatory figure plate showing in its parts 2A, 2B, 2C, 2D the various steps of peeling a lettuce head before coring,

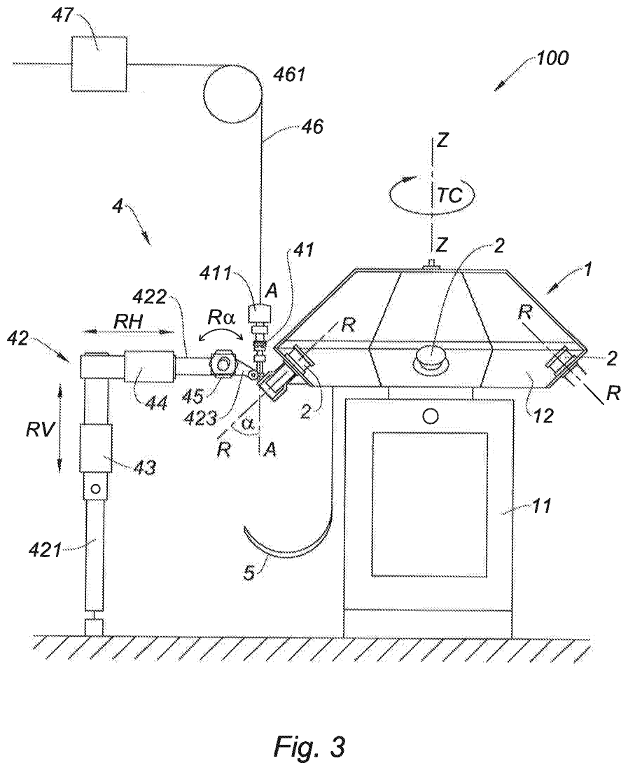

FIG. 3 is a schematic side view of an industrial peeling installation with the coring device according to the invention,

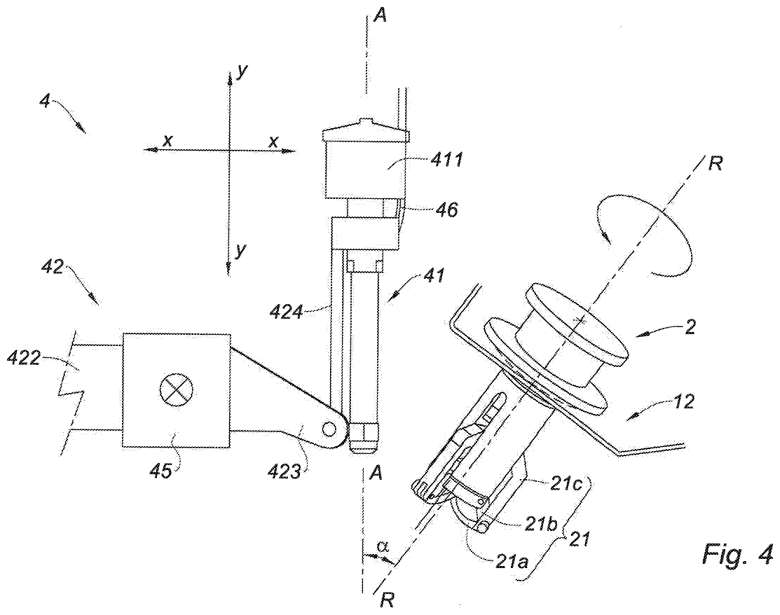

FIG. 4 is a schematic detailed view of the coring device,

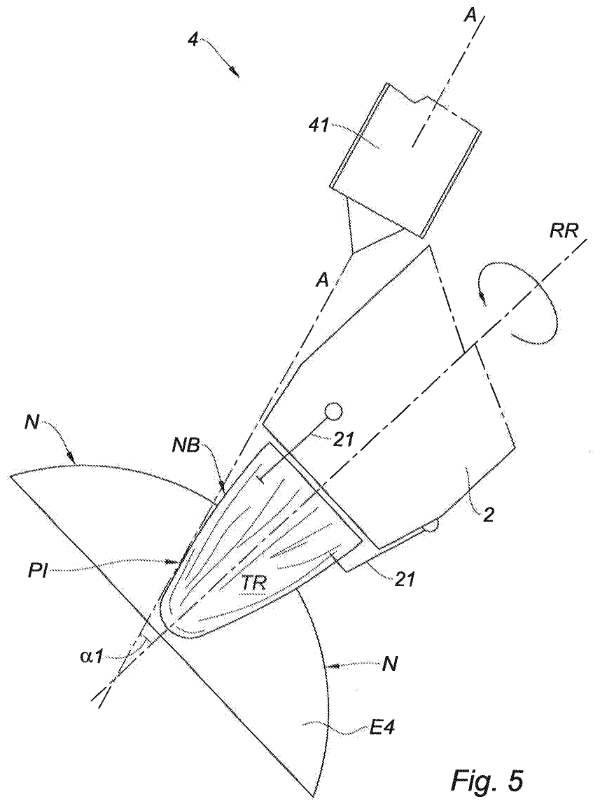

FIG. 5 is a block diagram of the coring process,

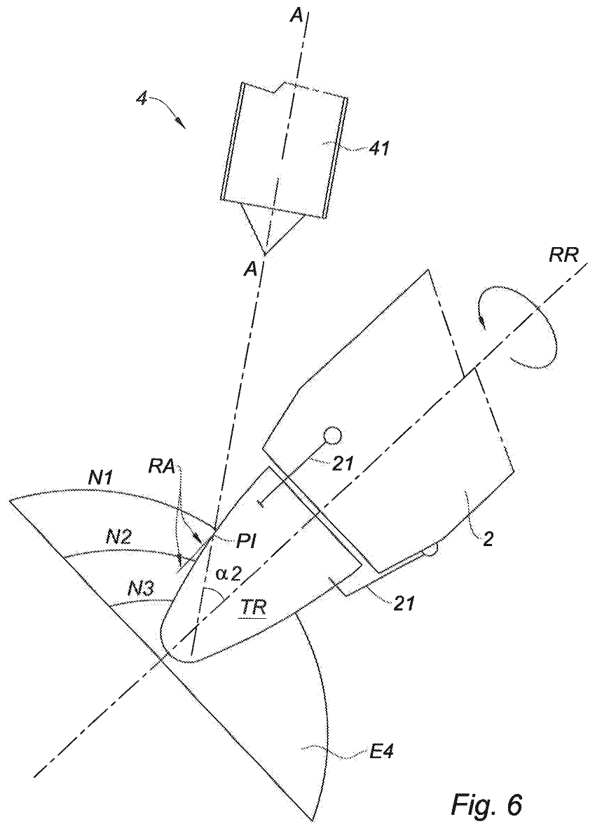

FIG. 6 is a block diagram of the coring process,

### DESCRIPTION OF EMBODIMENTS OF THE INVENTION

FIG. 1 is a top view diagram of an industrial peeling installation with 100 heads of lettuce TS. This installation 100 comprises of a transfer installation formed of a carousel 1 receiving the lettuce heads TS, placed automatically or manually, one by one, to feed them with carousel 1 to the cutting stations P1, P2, P3 to prepare each head then cut it in stages and collect separately the various parts of the lettuce leaves. These operations are carried out in a continuous kinematic process since the head TS is mounted on a rotating support 2 carried by the rotating carousel 1. The heads TS are attached by fasteners 21 to the rotating supports 2 holding each core TR. The cutting operations end with the coring process, which consists in separating the last parts of the lettuce leaves connected to the base of head TS around the end of the core TR. Then, the core TR, removed from the leaf pieces, is disposed of.

To simplify the description, the lettuce head TS could be considered to be an object of revolution with an axis of symmetry passing through the core TR. It can be assumed that this axis of symmetry of the lettuce head attached to support 2 coincides with the axis of rotation RR of the rotating support 2.

The successive cuts are made using disc-shaped rotating knives in front of which the lettuce heads TS pass while turning about their axis RR.

The movement of the carousel 1 about its axis ZZ is one of rotation movement stoppage of the rotation each time a lettuce head TS is to be placed on a rotating support 2 reaching the supply station Po. This brief stop is also used for coring, in the coring station Pₙ whose adjustable monitor 41 generating the cutting water jet is attached with its cutting line AA, the lettuce head TS being carried by the rotating support 2 rotating through this cutting line AA.

Other cutting operations may possibly be carried out on the fly.

For the installation of a lettuce head TS, it may be simply sufficient to temporarily slow down the rotation speed of the carousel 1; the same applies if the rotation speed of the support 2 about its axis RR near the coring station Pₙ is fast compared to the displacement speed or circulation speed on the path TC of the carousel 1. The core TR will then be cored on an envelope surface that will not strictly be a surface of revolution.

In more detail, carousel 1 is a plate or a box 12 mounted to rotate ZZ on a frame 11 and driven in circulation automatically or manually (see FIG. 3).

The operation of installation 100 is managed by the control unit 160. In installation 100 surrounded by a wall 150, the workstations P1 . . . Pₙ are set out around the carousel 1 downstream of the supply station Po where an operator or an automatic loader presents the lettuce heads TS one by one, with the core facing towards the rotating support 2. The lettuce head TS is then hung by its core TR by automatically inserting the attaching devices 21 of the rotating support 2. The assembly comprising support 2 carrying the head can then rotate about its axis of rotation RR.

The supply station Po is followed by cutting stations P1, P2, P3 . . . through which the TC circular path of the lettuce heads TS passes. Each cutting station P1, P2, P3 . . . comprises one or several rotary knives 31, driven by a motor 32, preferably disc-shaped and on which the lettuce head TS passes while rotating about its axis RR. Depending on the successive parts of the leaf to be cut from each TS lettuce head, the knives 31 act separately or simultaneously. The parts of the cut leaves are evacuated and collected separately by unrepresented transfer means.

The last part of the installation is the coring station Pn which receives the residue E4 from the lettuce head cut transversely above the core TR.

The coring station Pₙ includes blanking coring 4, which is described in detail below.

In a variant, if this transversal cut is not already done upstream, a transversal cutting device 3a is built into the coring station Pn.

The coring station Pn in which the residue E4 of the lettuce head TS carried by the rotating support 2 arrives, includes a water jet monitor 41 whose cutting axis AA is set to aim at the core TR at the greatest tangent possible and cut the base of the leaves to separate them from the core TR.

In practice, an orientation of the AA axis at an exact tangent to the core shell is not possible because the core TR does not end in a conical surface of rotation. However, by setting the cutting axis AA as close as possible to the fastening devices 21, it is moved near to the base of the main ribs of the lettuce leaf crowns; by an angular sweep (slight variation in the angle α) it is possible to target successive leaf base crowns during the rotation of the core TR. The power of the jet adjustable to suit the nature of the lettuces must be sufficient to cut the main rib of the lettuce leaves without damaging the core since it is much harder than the main ribs of the leaves. The projected droplets deflected by the surface of the core TR have sufficient energy to cut the base of the ribs on successive peripheral trajectories, without cutting the core itself and thus leaving hard pieces at the base of the ribs of the cut leaves.

After this coring operation, the fastening devices 21 are opened and the stripped core TR falls off the support 2 which once again reaches the supply station Po.

The various dressing and cutting operations are depicted schematically in FIG. 2 in which Parts 2A-2D represent the lettuce head TS in its inverted position, suspended so that the base of the core TR (is uppermost) on the hanging support 2 side and rotates about its axis RR.
Part 2A shows two knives C1, C2 used for cutting and which cut the lettuce head TS on the depicted planes, to remove the inedible ends of the leaves; the untouched cut head then remains in its state E1.
Part 2B shows the second step of using the knives C3, C4, C5 to make a succession of three cuts of the top (knife c3), the peripheral side (knife C4) and the base of the outer leaves (knife C5) to detach these leaves from the base of the core, leaving the cut head untouched in its state E2.
Part 2C shows the following cuts of the top (knife C6) and of the peripheral wall (knife C7) leaving the cut lettuce head untouched in its state E3.
Part 2D shows the last cut before coring to remove the heart of the lettuce (knife C8). This cutting is done substantially transversely, i.e. perpendicular to the rotation axis RR of the lettuce. The part of the lettuce near the tip of the core that constitutes the low residue E4 around the core TR remains.
The last operation, coring, is not represented in this figure plate; it will be described at a later using the coring device according to the invention.

In the current state of the art, coring is done with a pointed straight-bladed knife held at an angle to the axis of rotation RR in the lettuce head TS in its state E4. The blade is oriented in direction d (part 2D) while part E4 of the lettuce head rotates; it thus cuts the base of the ribs of the core leaves into a conical shape, separating the last pieces of the lettuce leaves while leaving significant parts of the leaves still attached to the cores.

The core is detached from the rotating support 2 which returns to the supply station Po to receive a new head of lettuce to prepare.

FIG. 3 is a simplified front view of the industrial peeling installation 100, limited to its part located at the coring station Pn. The machine frame 11 carries the carousel 1 with rotary supports 2 equipped with hook-shaped attaching devices 21 allowing the lettuce head TS to be firmly fixed and held on each rotary support 2. The carousel 1 which carries the supports 21 in this case is made of a biconeshaped box 12 with a hexagonal section, and facets equipped with four rotary supports 2.

Box 1 houses the equipment to ensure the stopping or rotation of the supports about their axis RR and actuating the attaching devices 21.

According to FIGS. 1 and 3, the coring device 4, analyzed separately from the installation consists of:
a rotating support 2 receiving the lettuce head TS,
An adjustable strength hyperbaric water jet monitor 41, controlled, carried by boom 42 adjustable so as to direct the cutting jet onto the base of the lettuce head TS as close as possible to the attaching devices 21 of the core TR securing it to the rotating support 2.

The cutting water jet monitor 41 has a nozzle defining the axis AA of the jet which is the cutting axis. The adjustable high-pressure water supply, for 2000 bar, is provided by a pipe 46 from a booster 47 with a loop 461 to absorb the adjustment movements of the monitor 41. The boom 42 includes a height-adjustable RV column 421 and a horizontal arm 422 for horizontal adjustment RH and ending with a pin 423 carrying monitor 41.

Column 421 is equipped with an actuator 43 for vertical adjustment RV and arm 422 is equipped with an actuator 44 for horizontal adjustment RH. Pin 423 is connected to arm 422 by an actuator 45 to adjust the orientation angle α of the axis AA in the plane of the figure. But it is also possible to use an actuator 45 allowing a rotational movement in all three axes.

The adjustment of the cutting axis AA in its position and angle is remote controlled. This may involve a number of pre-established settings based on the geometric characteristics of the lettuces, particularly in the core area, to adapt these settings accurately to the coring, in addition to cutting the leaves. Setting can also be done by eye, on a stationary installation 100 and a coring station Pₙ which is safely accessible in.

The cutting control is synchronized with the rotational movement of carousel 1 with the switching on and off of monitor 41 by program.

FIG. 3 shows a chute 5 under the coring area to collect loose leaf pieces. Covers or screens partially enclose the coring area. These means are not shown.

FIG. 4 shows the details of the coring device 4 consisting of the rotating support 2 combined with the jet monitor 41 adjustable by boom 42 and supplying adjusted water flow to the water jet, directed along the cutting axis AA.

The monitor 41 is mounted in a collar support 424 of adjustable pin 423 so that it can be easily removed for maintenance operations.

The rotating support 2 axis RR has three retractable claw-shaped attaching devices 21 shown here in the retracted position. The three claws 21 have a curved leg 21a mounted on a pivoting tab 21b and a controlled lever 21c. The water jet lance 41 carried by the stem 42 is adjustable in the XY plane and in inclination (angle α) in relation to the RR axis of rotation of holder 2 and lettuce head, which allows precise positioning of the cutting line AA in relation to the core.

FIG. 5 shows the operation of the coring device 4 in action on a residue E4.

The residue E4 of a lettuce head cut perpendicular to its axis RR, near the end of the core TR, is carried by the non-detailed claws 21 of the rotating support 2. The cutting axis AA of the monitor 41 directed to pass as close as possible to the claws 21 and minimize leaf loss.

The cutting axis AA is adjusted in a position skimming the natural surface, not exactly of a curved shape of the core TR.

With few exceptions, the TR cores of a series of TS lettuce heads are approximately the same shape so that the angle and position adjustment of the cutting jet materialized by the AA axis will be the same. This axis AA substantially meets the base of the main ribs N of the successive leaf crowns of the residue E4.

The strength of the jet is adjusted according to the relative hardness of the base of the main ribs and the trajectory: the hardness of the core, compared to that of the ribs and even to the base of the ribs, is sufficiently different to allow the appropriate setting of the jet so that it the ribs without cutting the core. The setting can be at the limit of this pressure range so that even if the point of impact PI of the jet on the rotating core TR does not correspond exactly to a crown of rib NB bases, the energy of the droplets deflected after their impact at the point of impact PI is sufficient to detach the leaves. This effect is used if the cutting axis AA cannot be a skimming angle (angle α1) as shown in FIG. 5 and that the angle must be widened α2 as in FIG. 6.

FIG. 6 shows schematically the case of a cutting axis AA that is not at a skimming angle (tangent) to the surface of the core TR. Diagrammatically, the rings of ribs N1, N2, N3 are generally cut successively during the rotation of the residue E4, allowing the cutting jet to move from a ring N1 to the next ring N2 and then on to the next ring N3. The cut clears the ring N1 giving access to the next ring N2, even if it is not exactly at the intersection of the cutting axis AA and the surface of the core TR. The return of droplets to the surface of the core TR is schematized by the lines RA.

The jets of droplets RA deflected at the point of impact PI of the cutting axis AA and the surface of the core TR successively work on the rib rings N1, N2, N3 and cut them.

The strength of the cutting jet setting is adjusted according to the experimental data collected for different types of lettuces.

It should be noted that residues E4 are cut parts of lettuce heads TS with fairly uniform dimensional and geometric characteristics within the limits of plant products. The characteristics of the angle settings a and point of impact PI of the cutting axis AA are to be interpreted in this context of possible accuracies for natural products.

Thus, in particular, the PI impact point of the cutting axis AA and the surface of the TR core is, when possible, a point of tangency to this surface, with a certain imprecision since the TR core rotates and its surface is not a surface of revolution. The point of impact PI is an average point located either at the base NB of the first ring N, N1 of the ribs, or between this ring and that of the following ribs N2, N3.

The jet power adjustment comes under the same considerations although the evident difference in hardness of a core and the ribs of its leaves accepts an adjustment requiring less precision.

Finally, it is worth recalling that since cutting and coring operations are carried out during the rotation of the E4 residue about its axis, the point of impact or tangency moves on a “circular” curve.

Although the above description refers to heads of lettuce, the invention applies to any type of plant with a leaf-bearing core, such as cabbage, which requires such coring. The term lettuce head should therefore be used in a non-restrictive sense for the application of the coring process and device depending on the invention.

### NOMENCLATURE

100 Industrial peeling installation
150 Enclosure
160 Control unit
1 Carousel
   11 Frame
   12 Case
2 Rotary support
   21 Fastener, hook
      21a Curved arm
      21b Tab
      21c Lever
3 Cutting device
   3a Transversal cutting device
   31 Cutting disc
   32 Motor
4 Coring device
   41 Cutting water jet nozzle
      411 Solenoid valve
   42 Boom
      421 Column
      422 Arms
      423 Pin
      424 Collar holder
   43 Vertical adjustment actuator
   44 Horizontal adjustment actuator
   45 Angular actuator
   46 High pressure water pipe
      461 Loop
   47 Booster
5 Chute
TS Lettuce head
TR Core
E1, E2, E3 Successive cutting states of the head TS
E4 Residue
N1, N2, N3 Main leaf ribs
NB Rib base
C1-C8 Knives
Po Supply station
P1, P2, P3 Cutting stations
Pn Coring station
ZZ Carousel rotation axis
XX Horizontal direction
YY Vertical direction
RH Horizontal adjustment
RV Vertical adjustment
Rα Angular adjustment
AA Cutting axis
RA Deflected droplet jets
PI Impact point of the cutting axis on surface of core
RR Rotary axis of rotation of rotating support
α1, α2 Angles of inclination of cutting axis with respect to the rotation axis
d Direction of core cutting with knife

1) Process for coring a lettuce head,
characterized in that
the lettuce head (TS) is fixed to a rotating support (2) of a shaft (RR)
the lettuce head (TS) is cut transversely to its shaft (RR) above the core (TR), leaving a residue (E4) formed by the core (TR) with leaf remains,
the power of a cutting water jet is adjusted according to the different hardnesses of the core (TR) and the main ribs (N1, N2, N3) of the leaves,
the residue (E4) is made to rotate while a jet of cutting water forming a cutting axis (AA) is directed at the residue (E4) core base so that the cutting line (AA) shaves the surface of the core at the incipient point of the leaves and cuts the base (NB) of the main rib of the lettuce leaves to separate the leaf remains from the core (TR).

2) Covering panel according to claim 1,
characterized in that
the axis (AA) of the cutting jet is oriented so that it is substantially tangent to a middle point (PI) with respect to the surface of the core TR.

3) Industrial peeling process for lettuce heads using the coring process according to claim 1,
characterized in that
the lettuce head (TS) is fixed to a rotary shaft support (2) (RR),
different leaf parts of the lettuce head (TS) are cut successively by rotating it with the rotating support (2) in front of knives (31) to cut successive leaf pieces,
the lettuce head (TS) is finally cut transversely to its axis (RR) just above the end of the core (TR) leaving a leaf residue (E4),
the power of the cutting water jet is adjusted according to the different hardnesses of the core (TR) and the main ribs (N1, N2, N3) of the leaves,
the residue (E4) is rotated and
the cutting water jet (cutting axis (AA) is directed at the base of the core (TR) at the beginning of the leaves to separate the leaf pieces and the core (TR).

4) Device for coring lettuce heads
including:
a rotating support (2) for receiving the lettuce head (TS) fixed to the support (2) by its core (TR) oriented according to the axis of rotation (RR) of the support (2),
a transversal cutting device (3a) for cutting the lettuce head (TS) transversely to its axis just above the core (TR) and forming a residue (E4) comprising the core (TR) and the bases of the leaves from the core,
an adjustable-strength cutting water jet monitor (41), mounted to be adjustable so that its cutting axis (AA) intercepts the volume of the residue (E4) at the base of the leaves of the lettuce head,
an over-pressurized water supply (47) to the monitor (41) and,
a control unit (160) managing the operation of the transverse cutting device (Pₙ), the rotating support (2) and the cutting water jet nozzle (41).

5) Industrial peeling plant for lettuce heads comprising:
a set of rotating supports (2) for transferring heads of lettuce (TS) between the entrance of the installation (100) and the evacuation of the core (TR) stripped of the lettuce leaves,
a supply station (Po) for loading the lettuce heads (TS) on the rotating supports (2),
a succession of cutting stations (P1, P2, P3 . . . ) to cut successively pieces of leaves according to the products to be obtained,
a coring device (4) according to claim 4 downstream of the cutting stations (P1, P2, P3 . . . ) for coring the residue (E4) cut from the lettuce head, collecting the remaining leaves and removing the stripped core and,
a control unit (160) which manages the synchronized operation of the sealing device (4) and the other components of the plant.

6) Industrial peeling plant for lettuce heads according to claim 5, characterized in that
all the rotating supports (2) for transferring the heads of lettuce are made up of a carousel (1) around which the various cutting stations (P1, P2, P3 . . . ) and the coring device (4) are distributed.
